(19) United States
(12) Patent Application Publication
(10) Pub. No.: US 2019/0098905 A1
(43) Pub. Date: Apr. 4, 2019

(54) BAKING MIX AND METHODS OF MAKING SAME

(71) Applicant: Bloomfield Farms, Inc., Bardstown, KY (US)

(72) Inventors: Matthew Elder, Loretto, KY (US); Daniel B. Sutherland, Taylorsville, KY (US)

(21) Appl. No.: 16/208,109

(22) Filed: Dec. 3, 2018

Related U.S. Application Data
(63) Continuation of application No. 15/093,105, filed on Apr. 7, 2016, now abandoned.
(60) Provisional application No. 62/144,184, filed on Apr. 7, 2015.

(51) Int. Cl. A21D 10/00; A21D 8/04

(52) U.S. Cl. CPC A21D 10/005; A21D 8/047

(57) ABSTRACT

A baking mix is provided that is free of common food allergens. The baking mix includes a modified starch, a native starch, a gluten-free flour, a hydrocolloid, a hydrogenated oil, a sugar, and a salt. Methods of manufacturing a baking mix are further provided and comprise the step of combining an amount of a modified starch, an amount of a native starch, an amount of a gluten-free flour, an amount of a hydrocolloid, an amount of a sugar, and an amount of a sea salt to form a raw material mixture. An amount heated hydrogenated oil is then added to the raw material mixture, and the raw material mixture is turbolized for a predetermined amount of time to thereby form the baking mix.

### RELATED APPLICATIONS

This application is a continuation of U.S. application Ser. No. 15/093,105, filed Apr. 7, 2016, which claims priority from U.S. Provisional Application Ser. No. 62/144,184, filed Apr. 7, 2015, the entire disclosures of which are incorporated herein by this reference.

### TECHNICAL FIELD

The presently-disclosed subject matter relates to baking mixes and methods of making the same. In particular, the presently-disclosed subject matter relates to baking mixes that are free of common food allergens and methods of making such a mix.

### BACKGROUND

Each year, millions of individuals have allergic reactions to food, which arise when the body of an individual has an abnormal response to a certain food product or ingredient within that food product. Generally, most food allergies only cause relatively mild and minor symptoms, but some food allergies can cause severe reactions and can be life-threatening. In this regard, it is appreciated that although nearly any food is capable of causing an allergic reaction, eight foods are typically considered to account for ninety-percent of all food-allergic reactions in the United States. These foods include peanuts, tree nuts, milk, eggs, wheat, soy, fish, and shellfish.

Currently, there is no cure for food allergies and avoidance of food allergens is often necessary to prevent serious health consequences. Unfortunately, however, at least one of the foregoing eight foods is present in some form in many of the food products available today. For example, gluten is a protein composite found in wheat and related grains, including barley and rye, and forms when glutenin molecules cross-link to form a sub-microscopic network attached to gliadin. Gluten is frequently found in baked products as it gives elasticity to doughs, such as bread dough, and aids in the rising of dough during baking processes. Gluten also allows dough to retain its shape and additionally allows a completed baking product to have a desired, chewy texture. For example, if a gluten-containing dough is leavened with yeast, the fermentation of the dough produces carbon dioxide bubbles, which, when trapped by the gluten network, cause the dough to rise. Subsequent baking of the dough then coagulates the gluten, which, along with starch, stabilizes the shape of the final product.

Despite the seemingly beneficial nature of gluten, the presence of gluten in bread and other baking mixes has recently been linked to a number of health problems, particularly in individuals known to suffer from celiac disease and wheat allergy. For instance, in sufferers of celiac disease, even a modest daily intake of gluten has been shown to result in a number of histological abnormalities within the small intestine of those individuals. As such, a number of bread and making mixes have recently been developed that are free of gluten. In developing such mixes, however, eggs are frequently introduced into the mixtures to replace the benefits previously provided by gluten. In this regard, in replacing the gluten with eggs, such mixes have essentially only achieved the replacement of one common allergen (i.e., gluten) with another (i.e., eggs). Accordingly, a baking mix that is free of the common eight allergens and that can be produced on a commercial scale would be both highly desirable and beneficial.

### SUMMARY

The presently-disclosed subject matter meets some or all of the above-identified needs, as will become evident to those of ordinary skill in the art after a study of information provided in this document.

This summary describes several embodiments of the presently-disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this summary or not. To avoid excessive repetition, this summary does not list or suggest all possible combinations of such features.

The presently-disclosed subject matter includes baking mixes that are free of common food allergens and methods of making such a mix. In some embodiments, a baking mix is provided that comprises about 30 wt % to about 50 wt % of a modified starch; about 10 wt % to about 50 wt % of a native starch; about 15 wt % to about 85 wt % of a gluten-free flour; about 1 wt % to about 20 wt % of a hydrocolloid; about 2 wt % to about 15 wt % of a hydrogenated oil; about 1 wt % to about 10 wt % of a sugar; and about 0.25 wt % to about 5 wt % of a salt.

With respect to the baking mixes described herein, in some embodiments, the modified starch included in an exemplary baking mix is selected from the group consisting of modified tapioca starch, modified corn starch, modified potato starch, modified tapioca dextrin starch, and combinations thereof. For example, in certain embodiments, the modified starch is modified tapioca starch and is included in the baking mix in an amount of about 30 wt % to about 50 wt %.

In some embodiments of the presently-disclosed baking mixes, the native starch is selected from the group consisting of potato starch, corn starch, tapioca starch, and combinations thereof. For example, in certain embodiments, the baking mix comprises about 5 wt % to about 25 wt % of a potato starch and about 5 wt % to about 25 wt % of a corn starch.

In some embodiments, the gluten-free flour included in an exemplary baking mix is selected from the group consisting of rice flour, brown rice flour, sweet waixy rice flour, millet flour, sorghum flour, rice bran extract, and combinations thereof. For example, in some embodiments, the baking mix comprises about 15 wt % to about 35 wt % of a rice flour, about 1 wt % to about 25 wt % millet flour, and about 1 wt % to about 25 wt % sorghum flour.

In some embodiments, the baking mix includes a hydrocolloid that is selected from the group consisting of hydroxypropyl methyl cellulose, xantham gum, guar gum, sodium alginate gum, carrageenan gum, and combinations thereof. As an example of such a baking mix, in some embodiments, a baking mix comprises about 1 wt % to about 10 wt % of hydroxypropyl methyl cellulose, about 0.01 wt % to about 5 wt % xanthum gum, and about 0.01 wt % to about 5 wt % guar gum.

Further, with respect to the hydrogenated oil, sugar, and salts included in an exemplary baking mix of the presently-disclosed subject matter, in some embodiments, the hydrogenated oil is selected from the group consisting of palm oil, canola oil, soybean oil, and sunflower oil. In certain embodiments, the baking mix comprises about 2 wt % to about 15 wt % palm oil. In some embodiments, the baking mix includes a sugar selected from the group consisting of evaporated cane juice, turbinado sugar, white sugar, brown sugar, dextrose, and raw sugar. In some embodiments, the baking mix comprises about 1 wt % to about 10 wt % evaporated cane juice. In some embodiments, the salt included in the baking mix is selected from the group consisting of sea salt, table salt, and kosher salt. In some embodiments, the baking mix comprises about 0.25 wt % to about 5 wt % sea salt.

In one embodiment of the exemplary baking mixes described herein, the baking mix comprises: about 35 wt % tapioca starch as the modified starch; about 10 wt % potato starch and about 9 wt % corn starch as the native starch; about 24 wt % rice flour, about 4 wt % millet flour, about 2 wt % sorghum flour, and about 0.5 wt % rice bran extract as the gluten-free flour; about 2 wt % hydroxypropyl methyl cellulose, about 0.5 wt % xanthum gum, and about 0.5 wt % guar gum as the hydrocolloid; about 6 wt % palm oil as the hydrogenated oil; about 5% evaporated cane juice as the sugar; and about 2% of a sea salt as the salt. In some embodiments, the baking mix can further comprise an effective amount of a mold inhibitor, a crumb softener, or both.

Further provided by the presently-disclosed subject matter are methods for manufacturing a baking mix. In some embodiments, a method for manufacturing a baking mix is provided that comprises a first step of combining an amount of a modified starch, an amount of a native starch, an amount of a gluten-free flour, an amount of a hydrocolloid, an amount of a sugar, and an amount of a sea salt to form a raw material mixture. An amount of heated hydrogenated oil is then added to the raw material mixture, and the raw material mixture is subsequently turbolized for a predetermined amount of time to thereby form the baking mix. In some implementations of such a method, the step of turbolizing the raw material mixture comprises turbolizing the mixture for about 30 minutes.

Still further provided by the presently-disclosed subject matter are methods of preparing a bread product. In some implementations, a method of preparing a bread product is provided in which a baking mix is first provided that includes about 30 wt % to about 50 wt % of a modified starch, about 10 wt % to about 50 wt % of a native starch, about 15 wt % to about 85 wt % of a gluten-free flour, about 1 wt % to about 20 wt % of a hydrocolloid, about 2 wt % to about 15 wt % of a hydrogenated oil, about 1 wt % to about 10 wt % of a sugar, and about 0.25 wt % to about 5 wt % of sea salt. Upon providing the bread product baking mix, the bread mix is then mixed with an amount of water and an amount of yeast to form a dough, and the dough is then baked for a predetermined amount of time.

Further features and advantages of the present invention will become evident to those of ordinary skill in the art after a study of the description, figures, and non-limiting examples in this document.

### BRIEF DESCRIPTION OF THE DRAWINGS

Not applicable.

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Unless defined otherwise, all technical and scientific terms used herein have the same meaning as is commonly understood by one of skill in the art to which the invention(s) belong. All patents, patent applications, published applications and publications, databases, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. Further, unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

The present application can “comprise,” “consist essentially of,” or “consist of” the components of the present invention (e.g., the baking mixes) as well as other ingredients or elements described herein. As such, although the present invention is generally described herein as “comprising” various components, it is understood that the present invention can also be described as “consisting essentially of” or “consisting of” the various components. For example, in some embodiments, a baking mix can be understood as “comprising” various components and is thus open ended, meaning that the mix includes the ingredients recited, or their equivalent in structure or function, plus any other ingredient or ingredients which are not recited. As another example, in other embodiments, a baking mix can be described as “consisting essentially of” various ingredients such that the baking mix includes the specified ingredients as well as those that do not materially affect the basic characteristic(s) of the claimed invention (e.g., additional ingredients that do not include gluten and eggs and/or other allergens). As yet another example, in some embodiments, a baking mix can be described as “consisting of” various ingredients such that the baking mix excludes any ingredient that is not particularly specified.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The presently-disclosed subject matter includes baking mixes and methods of making the same. In particular, the presently-disclosed subject matter includes baking mixes that are free of the most common food allergens, and, in that regard, are formulated to function without the presence of eggs and other common allergens. In some embodiments, a baking mix is provided that comprises about 30 wt % to about 50 wt % of a modified starch; about 10 wt % to about 50 wt % of a native starch; about 15 wt % to about 85 wt % of a gluten-free flour; about 1 wt % to about 20 wt % of a hydrocolloid; about 2 wt % to about 15 wt % of a hydrogenated oil; about 1 wt % to about 10 wt % of a sugar; and about 0.25 wt % to about 5 wt % of sea salt.

With respect to the modified starch included in the baking mixes of the presently-disclosed subject matter, the term “modified starch” is used interchangeably herein with the term “starch derivatives” to describe starches that have been physically, enzymatically, or chemically treated to change the properties of the starch. Such changes in the properties of a starch include, but are not limited to: increases in the stability of the starch against excessive heat, acid, shear, time, cooling, or freezing; changes in the texture of the starch; decreases or increases in the viscosity of the starch; lengthening or shortening the gelatinization time of the starch; or increases in the visco-stability of the starch. Various methods of producing such modified starches are known to those of ordinary skill in the art. In some embodiments, the modified starch included in an exemplary baking mixture is selected from the group consisting of modified tapioca starch, modified corn starch, modified potato starch, modified tapioca dextrin starch, and combinations thereof. In some embodiments, the modified starch is modified tapioca starch that, in certain embodiments, is present in the baking mixture in an amount equal to about 30 wt % to about 50 wt % of the baking mixture.

With respect to the native starches included in the baking mixes, the term “native starch” is used herein to describe carbohydrates that typically consist of a large number of glucose units joined by glycosidic bonds, and that, while typically processed, have not been extensively altered by physical, enzymatic, or chemical treatment. In some embodiments, the native starch is selected from the group consisting of potato starch, corn starch, tapioca starch, tapioca dextrin starch, and combinations thereof. In some embodiments, the baking mix comprises about 5 wt % to about 25 wt % of a potato starch and about 5 wt % to about 25 wt % of a corn starch.

The gluten-free flour or flours included in the baking mixes of the presently-disclosed subject matter are typically those flours that are known to those skilled in the art and are produced from sources other than wheat and related grains that are known to include gluten. Such gluten-free flours include, but are not limited to, rice flour, brown rice flour, sweet waixy rice flour, millet flour, sorghum flour, rice bran extract, and combinations thereof. In some embodiments, the baking mix comprises about 15 wt % to about 35 wt % of a rice flour, about 1 wt % to about 25 wt % millet flour, and about 1 wt % to about 25 wt % sorghum flour.

The term “hydrocolloid” or “hydrophilic colloid” is used herein to refer to the heterogeneous group of long chain polymers (polysaccharides and/or proteins) that are generally characterized by their ability to form viscous dispersions and/or gels when dispersed in water. Typically, the presence of a large number of hydroxyl (—OH) groups in the polymers markedly increases the affinity of the polymers for binding water molecules, thus rendering them hydrophilic compounds. In this regard, a suspension of a hydrocolloid in water will typically result in the hydrocolloid particles binding to the water and to one another. In some embodiments, the hydrocolloids used in the baking mixes of the presently-disclosed subject matter are selected from hydroxypropyl methyl cellulose, xantham gum, guar gum, sodium alginate gum, carrageenan gum, and combinations thereof. In some embodiments, the baking mix comprises about 1 wt % to about 10 wt % of hydroxypropyl methyl cellulose, about 0.01 wt % to about 5 wt % xanthum gum, and about 0.01 wt % to about 5 wt % guar gum.

Turning now to the hydrogenated oils included in the baking mixes of the presently-disclosed subject matter, the term “hydrogenated oil” refers to those oils that are typically used in baking applications and in which hydrogen has been introduced into the oil to reduce or saturate the oils. In some embodiments, the hydrogenated oil is selected from the group consisting of palm oil, canola oil, soybean oil, and sunflower oil. In some embodiments, the baking mix comprises about 2 wt % to about 15 wt % palm oil.

With respect to the sugars and salts included in an exemplary baking mix of the presently-disclosed subject matter, a number of suitable sugars and salts known to those skilled in the art can be used in accordance with the presently-disclosed subject matter. For example, in some embodiments, the sugar is selected from the group consisting of evaporated cane juice, turbinado sugar, white sugar, brown sugar, dextrose, and raw sugar. In some embodiments, the baking mix comprises about 1 wt % to about 10 wt % evaporated cane juice. As an example of a salt that can be included in the baking mixes, in some embodiments, the salt included in the baking mix is selected from the group consisting of sea salt, table salt, and kosher salt. In some embodiments, the baking mix comprises about 0.25 wt % to about 5 wt % sea salt.

In one exemplary embodiment of a baking mix made in accordance with the presently-disclosed subject matter and using the foregoing ingredients, a baking mix is provided that comprises: about 35 wt % tapioca starch as the modified starch; about 10 wt % potato starch and about 9 wt % corn starch as the native starch; about 24 wt % rice flour, about 4 wt % millet flour, about 2 wt % sorghum flour, and about 0.5 wt % rice bran extract as the gluten-free flour; about 2 wt % hydroxypropyl methyl cellulose, about 0.5 wt % xanthum gum, and about 0.5 wt % guar gum as the hydrocolloid; about 6 wt % palm oil as the hydrogenated oil; about 5% evaporated cane juice as the sugar; and about 2% of a sea salt as the salt.

To prevent the baking mix from succumbing to mold upon using the baking mix to produce a bread or other baked product, in some embodiments, an effective amount of a mold inhibitor is further included in an exemplary baking mix. For instance, in certain embodiments, the baking mix includes about 0.1 wt % to about 2 wt % of Microgaurd 200 (Danisco) and about 0.1 wt % to about 2 wt % of ascorbic acid powder.

Further, to prevent any resulting baked product from staling, in some embodiments, a crumb softener is further included in an exemplary baking mix. For instance, in certain embodiments, a crumb softener, such as Softataste-GF 1000 (AB Mauri) is included in the baking mix in an amount of about 0.01 wt % to about 2 wt % of the baking mix.

An another exemplary embodiment of the presently-disclosed subject matter, a baking mix can be provided that includes the following ingredients shown in Table 1.

TABLE 1
Exemplary Baking Mix Ingredient List

| Ingredient Name | Wt % |
|---|---|
| Tapioca Starch, Modified (Cargill Cream Tex#75720) | 35.0250 |
| Rice Flour, White Long Grain (Florida Crystal Or Rivland) | 23.5900 |
| Potato Starch, (Avebe-Veendam Holland) 55.12 Bag | 9.4360 |
| Starch, Corn Pfp (Corn Products #034030-102) 50 Lb. Bag | 9.2000 |
| Palm Oil ((Lp958120nt) Aak) | 5.6400 |
| Evaporated Cane Juice (Florida Crystals/Domino) | 4.7180 |
| Millet Flour, Fine Grind (Agvanced Enterprises) | 3.7740 |
| Hydroxypropyl Methyl Cellulose #E464 (Methocel K4m) | 2.3590 |
| Sea Salt | 2.0760 |
| Sorghum Flour, Fine Grind (Advanced Enterprises) | 1.8870 |
| Xanthan Gum, (Jungbunzlauer) | 0.5660 |
| Guar Gum, Food Grade 30-70 (Pakistan Gum Or | 0.5660 |
| Colony Processing) | |
| Rice Bran Extract, Ribus (Nu Bake) 50 Lb. Bag | 0.4720 |
| Microguard 200 (Danisco) | 0.4720 |
| Softataste-GF 1000 (Ab Mauri) | 0.1250 |
| Ascorbic Acid Powder | 0.0940 |

Further provided, in some implementations of the presently-disclosed subject matter, are methods for making a baking mix. In some implementations, a method for making a bread mix is provided that comprises the steps of: combining an amount of a modified starch, an amount of a native starch, an amount of a gluten-free flour, an amount of a hydrocolloid, an amount of a sugar, and an amount of a sea salt to form a raw material mixture; adding an amount of heated hydrogenated oil to the raw material mixture; and turbolizing the raw material mixture for a predetermined amount of time. In some implementations, the step of turbolizing the raw material mixture comprises turbolizing the mixture for about 30 minutes.

In one implementation of a method for making a bread mix in accordance with the presently-disclosed subject matter, a bread mix is manufactured by first combining the raw ingredients listed above in Table 1 (with the exception of the palm oil) in a blender while the blender is running. The palm oil is then heated until the oil is present in liquid form, and the oil is then added to the raw ingredients in the appropriate wt %. The resulting raw mixture is then turbolized for 30 minutes until a granulation size is produced that ensures that the mixture is sufficiently turbolized and is complete.

Still further provided, in some embodiments, are methods of preparing a baking product, such as a bread. In some embodiments, a method of preparing a baking product is provided that includes the steps of: providing a baking mix of the presently-disclosed subject matter (e.g., the baking mix of Table 1); mixing the baking mix with an amount of water and an amount of yeast to form a dough; and baking the dough for a predetermined amount of time. For instance, in some implementations, to prepare a bread using the baking mixes described herein, the Bakers Percentage Formula shown below in Table 2 can be used to first scale each of the ingredients by weight based on the total weight of the dry mix used. Water at a temperature of between 100° F. and 110° F. is then added along with the yeast to mixing bowl, and the water and yeast are quickly whisked together until the yeast is evenly dispersed. The water and yeast mixture is then added to the baking mix and, using a paddle attachment on a planetary mixer (e.g. Hobart, Kitchen Aid), the ingredients are mixed on speed 1 for one minute. The bowl with the ingredients is then scraped, if needed, and the ingredients are mixed on speed 2 for an additional two minutes. After mixing, the desired dough weight is then deposited in baking pans, and the top of the dough is smoothed with a scraper before marking the top of the dough with 4 to 6 diagonal slashes approximately one quarter inch deep. The dough is then proofed in a commercial proofer for approximately 40 minutes at 100° F.-105° F., and then baked at 380° F.-385° F. for approximately one hour. After baking, the resulting bread can then be de-panned and allowed to completely cool before slicing.

TABLE 2
Bakers Percentage Formula.

| Ingredient | Bakers % | Lbs. | Lbs. |
|---|---|---|---|
| Baking Mix | 100% | 25 | 50 |
| Water (100° F.-110° F.) | 80% | 20 | 40 |
| Yeast - Active Dry | 1.89% | .473 | .95 |

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A baking mix, comprising:
about 30 wt. % to about 50 wt. % of a modified starch;
about 10 wt. % to about 50 wt. % of a native starch;
about 15 wt. % to about 85 wt. % of a gluten-free flour, the gluten-free flour consisting of about 15 wt. % to about 35 wt. % of a rice flour, about 1 wt. % to about 25 wt. % millet flour, and about 1 wt. % to about 25 wt. % sorghum flour;
about 1 wt. % to about 20 wt. % of a hydrocolloid, the hydrocolloid consisting of about 1 wt. % to about 10 wt. % of hydroxypropylmethyl cellulose, about 0.01% wt. % to about 5 wt. % xanthum gum, and about 0.01 wt. % to about 5 wt. % guar gum;
about 2 wt. % to about 15 wt. % of a hydrogenated oil;
about 1 wt. % to about 10 wt. % of a sugar; and
about 0.25 wt. % to about 5 wt. % of a salt,
the baking mix not including peanuts, tree nuts, milk, eggs, wheat, soy, fish, or shellfish.

2. The baking mix of claim 1, wherein the modified starch is selected from the group consisting of modified tapioca starch, modified corn starch, modified potato starch, modified tapioca dextrin starch, and combinations thereof.

3. The baking mix of claim 2, wherein the modified starch is modified tapioca starch.

4. The baking mix of claim 3, wherein the baking mix comprises about 30 wt. % to about 50 wt. % of a modified tapioca starch.

5. The baking mix of claim 1, wherein the native starch is selected from the group consisting of potato starch, corn starch, tapioca starch, and combinations thereof.

6. The baking mix of claim 5, wherein the baking mix comprises about 5 wt. % to about 25 wt. % of a potato starch and about 5 wt. % to about 25 wt. % of a corn starch.

7. The baking mix of claim 1, wherein the hydrogenated oil is selected from the group consisting of palm oil, canola oil, soybean oil, and sunflower oil.

8. The baking mix of claim 7, wherein the baking mix comprises about 2 wt. % to about 15 wt. % palm oil.

9. The baking mix of claim 1, wherein the sugar is selected from the group consisting of evaporated cane juice, turbinado sugar, white sugar, brown sugar, dextrose, and raw sugar.

10. The baking mix of claim 9, wherein the baking mix comprises about 1 wt. % to about 10 wt. % evaporated cane juice.

11. The baking mix of claim 1, wherein the salt is selected from the group consisting of sea salt, table salt, and kosher salt.

12. The baking mix of claim 11, wherein the baking mix comprises about 0.25 wt. % to about 5 wt. % sea salt.

13. The baking mix of claim 1, wherein the baking mix comprises:
about 35 wt. % tapioca starch as the modified starch;
about 10 wt. % potato starch and about 9 wt. % corn starch as the native starch;
about 0.5 wt. % of a rice bran extract;
about 6 wt. % palm oil as the hydrogenated oil;
about 5% evaporated cane juice as the sugar; and
about 2% of a sea salt as the salt.

14. The baking mix of claim 1, further comprising an effective amount of a mold inhibitor, a crumb softener, or both.

15. The baking mix of claim 1, wherein the baking mix consists of:
about 35 wt. % to about 36 wt. % of a tapioca starch;
about 23 wt. % to about 24 wt. % of a rice flour;
about 9 wt. % to about 10 wt. % of a potato starch;
about 9 wt. % to about 10 wt. % of a corn starch;
about 5 wt. % to about 6 wt. % of a palm oil;
about 4 wt. % to about 5 wt. % of an evaporated cane juice;
about 3 wt. % to about 4 wt. % of a millet flour;
about 2 wt. % to about 3 wt. % of a hydroxypropylmethyl cellulose;
about 2 wt. % to about 3 wt. % of a sea salt;
about 1 wt. % to about 2 wt. % of a sorghum flour;
about 0.5 wt. % to about 1 wt. % of a xanthum gum;
about 0.5 wt. % to about 1 wt. % of a guar gum;
about 0.25wt. % to about 0.5 wt. % of a rice bran extract;
about 0.25 wt. % to about 0.6 wt. % of a mold inhibitor; and
about 0.1 wt. % to about 0.2 wt. % of a crumb softener.

16. A method of manufacturing a baking mix, comprising:
providing a baking mix including
about 30 wt. % to about 50 wt. % of a modified starch;
about 10 wt. % % to about 50 wt. % of a native starch;
about 15 wt. % to about 85 wt. % of a gluten-free flour, the gluten-free flour consisting of about 15 wt. % to about 35 wt. % of a rice flour, about 1 wt. % to about 25 wt. % millet flour, and about 1 wt. % to about 25 wt. % sorghum flour;
about 1 wt. % to about 20 wt. % of a hydrocolloid, the hydrocolloid consisting of about 1 wt. % to about 10 wt. % of hydroxypropylmethyl cellulose, about 0.01% wt. % to about 5 wt. % xanthum gum, and about 0.01 wt. % to about 5 wt. % guar gum;
about 1 wt. % to about 10 wt. % of a sugar; and
about 0.25 wt. % to about 5 wt. % of a salt,
the baking mix not including peanuts, tree nuts, milk, eggs, wheat, soy, fish, or shellfish,
combining an amount of a modified starch, an amount of a native starch, an amount of a gluten-free flour, an amount of a hydrocolloid, an amount of a sugar, and an amount of a sea salt to form a raw material mixture;
adding an amount of heated hydrogenated oil to the raw material mixtureₛ the amount of hydrogenated oil equal to about 2 wt. % to about 15 wt. % of the baking mix; and
mixing the raw material mixture for a predetermined amount of time.

17. The method of claim 16, where the step of mixing the raw material mixture comprises mixing the mixture for about 30 minutes.

18. A method of preparing a bread product, comprising:
providing a baking mix, the baking mix including
about 30 wt. % to about 50 wt. % of a modified starch,
about 10 wt. % to about 50 wt. % of a native starch,
about 15 wt. % to about 85 wt. % of a gluten-free flour, the gluten-free flour consisting of about 15 wt. % to about 35 wt. % of a rice flour, about 1 wt. % to about 25 wt. % millet flour, and about 1 wt. % to about 25 wt. % sorghum flour,
about 1 wt. % to about 20 wt. % of a hydrocolloid, the hydrocolloid consisting of about 1 wt. % to about 10 wt. % of hydroxypropylmethyl cellulose, about 0.01% wt. % to about 5 wt. % xanthum gum, and about 0.01 wt. % to about 5 wt. % guar gum;
about 2 wt. % to about 15 wt. % of a hydrogenated oil,
about 1 wt. % to about 10 wt. % of a sugar, and
about 0.25 wt. % to about 5 wt. % of sea salt,
the baking mix not including peanuts, tree nuts, milk, eggs, wheat, soy, fish, or shellfish allergens;
mixing the bread mix with an amount of water and an amount of yeast to form a dough; and
baking the dough for a predetermined amount of time.

19. The method of claim 18, wherein the baking mix consists of:
about 35 wt. % to about 36 wt. % of a tapioca starch;
about 23 wt. % to about 24 wt. % of a rice flour;
about 9 wt. % to about 10 wt. % of a potato starch;
about 9 wt. % to about 10 wt. % of a corn starch;
about 5 wt. % to about 6 wt. % of a palm oil;
about 4 wt. % to about 5 wt. % of an evaporated cane juice;
about 3 wt. % to about 4 wt. % of a millet flour;
about 2 wt. % to about 3 wt. % of a hydroxypropylmethyl cellulose;
about 2 wt. % to about 3 wt. % of a sea salt;
about 1 wt. % to about 2 wt. % of a sorghum flour;
about 0.5 wt. % to about 1 wt. % of a xanthum gum;
about 0.5 wt. % to about 1 wt. % of a guar gum;
about 0.25wt. % to about 0.5 wt. % of a rice bran extract;
about 0.25 wt. % to about 0.6 wt. % of a mold inhibitor; and
about 0.1 wt. % to about 0.2 wt. % of a crumb softener.
